(19) United States
(12) Patent Application Publication
(10) Pub. No.: US 2025/0365587 A1
(43) Pub. Date: Nov. 27, 2025

(54) METHOD AND APPARATUS FOR REPORTING TRANSMIT PERFORMANCE ENHANCEMENT OF USER EQUIPMENT TO BASE STATION

(71) Applicant: MEDIATEK INC., Hsinchu City (TW)

(72) Inventors: Ming-Yu Hsieh, Hsinchu City (TW); Shih-Chieh Yen, Hsinchu City (TW); Timothy James Frost, Oulu (FI); Hsin-Ying Lee, Hsinchu City (TW)

(73) Assignee: MEDIATEK INC., Hsinchu City (TW)

(21) Appl. No.: 19/183,962

(22) Filed: Apr. 21, 2025

Related U.S. Application Data
(60) Provisional application No. 63/651,467, filed on May 24, 2024.

(51) Int. Cl. H04W 24/02

(52) U.S. Cl. CPC H04W 24/02

(57) ABSTRACT

A wireless communication method employed by a user equipment (UE) includes: generating a message, wherein the message includes at least one bit indicative of UE transmit (TX) performance enhancement; and sending the message to a base station (BS). The UE includes a wireless communication circuit and a control circuit. The control circuit is configured to generate the message, and instruct the wireless communication circuit to send the message to the BS.

### CROSS REFERENCE TO RELATED APPLICATIONS

This application claims the benefit of U.S. Provisional Application No. 63/651, 467, filed on May 24, 2024. The content of the application is incorporated herein by reference.

### BACKGROUND

The present invention relates to wireless communications, and more particularly, to a method and apparatus for reporting transmit (TX) performance enhancement of a user equipment (UE) to a base station (BS).

The performance/link quality from BS TX to UE receive (RX) is better than the quality from UE TX to BS RX. Thus, there are market demands about enhancement of UE TX coverage. However, in order to meet different regulatory UE-UE co-existence requirements, network signaling (NS) can be sent from BS to UE for configuring UE's TX additional maximum power reduction (A-MPR) (e.g., power backoff) for fulfilling these requirements. Moreover, another constraint is because of meeting the adjacent channel leakage ratio (ACLR) spectrum mask which results in UE TX MPR. In other words, to further enhance the UE TX ACLR performance is necessary.

UE TX coverage is reduced because of UE TX power backoff (e.g., A-MPR and/or MPR). For UE power class 3/2/1, the allowed MPR requirements are different. Especially, it is also studied that the higher TX MPR can be from the use of the high-order modulation. Therefore, because of the higher MPR, the higher-order UE TX modulation leads to weak coverage from network (NW) perspective.

With the aid of UE's high-cost (e.g., circuits' large area or high current) or advanced TX technical design (e.g., TX Digital Pre-Distortion (DPD) or low Peak to Average Power Ratio (PAPR)), certain radio-frequency (RF) specification performance can be enhanced. The enhanced UE TX RF performance can be associated with requirements about ACLR, A-MPR, MPR, error vector magnitude (EVM), TX output power, etc. In real scenarios, some UEs can have advanced design (e.g., TX DPD or low PAPR) to support good RF performance, but some UEs may only have conventional designs and support the minimum specification requirements. Because BS is not aware of UEs which support advanced TX design and enhanced TX RF performance, all of the good and legacy UEs are forced to meet minimum/worst specification requirements.

Thus, there is a need for an innovative UE TX performance enhancement reporting scheme which is capable of informing BS/NW of enhanced UE TX performance that is better than minimum/worst specification requirements, such that UE can benefit from enhanced TX coverage and/or enhanced TX throughput.

### SUMMARY

One of the objectives of the claimed invention is to provide a method and apparatus for reporting TX performance enhancement of a UE to a BS.

According to a first aspect of the present invention, an exemplary wireless communication method employed by a UE is disclosed. The exemplary wireless communication method includes: generating a message, wherein the message includes at least one bit indicative of UE TX performance enhancement; and sending the message to a BS.

According to a second aspect of the present invention, an exemplary UE is disclosed. The exemplary UE includes a wireless communication circuit and a control circuit. The control circuit is configured to generate a message, and instruct the wireless communication circuit to send the message to a BS, wherein the message includes at least one bit indicative of UE TX performance enhancement.

These and other objectives of the present invention will no doubt become obvious to those of ordinary skill in the art after reading the following detailed description of the preferred embodiment that is illustrated in the various figures and drawings.

### BRIEF DESCRIPTION OF THE DRAWINGS

FIG. 1 is a diagram illustrating a wireless communication system according to an embodiment of the present invention.

FIG. 2 is a diagram illustrating a case where a UE updates enhanced UE TX performance relevant to A-MPR to a BS.

FIG. 3 is a diagram illustrating a case where a UE updates enhanced UE TX performance relevant to ACLR to a BS.

FIG. 4 is a diagram illustrating that a UE boosts its TX output power for the power class 2 due to an enhanced ACLR.

### DETAILED DESCRIPTION

Certain terms are used throughout the following description and claims, which refer to particular components. As one skilled in the art will appreciate, electronic equipment manufacturers may refer to a component by different names. This document does not intend to distinguish between components that differ in name but not in function. In the following description and in the claims, the terms “include” and “comprise” are used in an open-ended fashion, and thus should be interpreted to mean “include, but not limited to . . . ”. Also, the term “couple” is intended to mean either an indirect or direct electrical connection. Accordingly, if one device is coupled to another device, that connection may be through a direct electrical connection, or through an indirect electrical connection via other devices and connections.

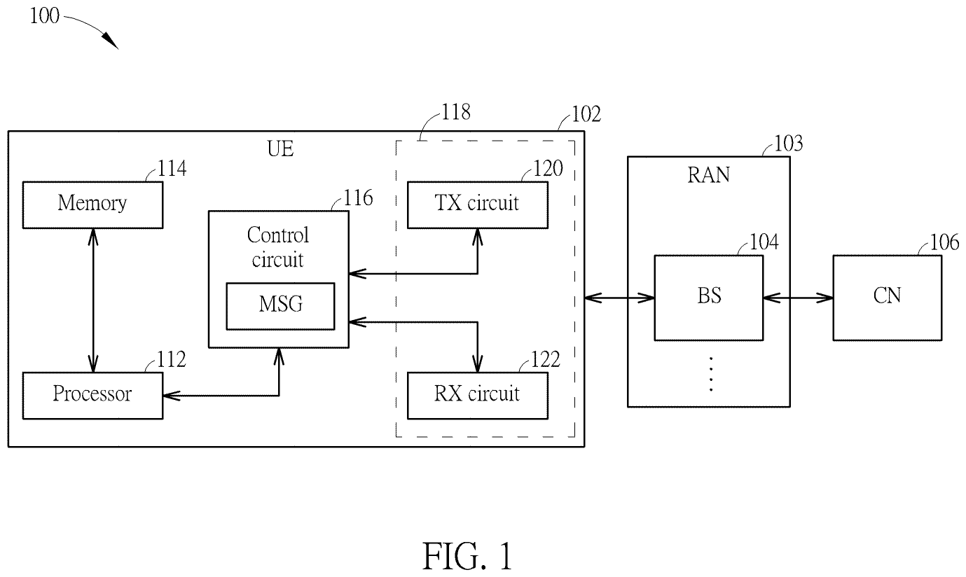

FIG. 1 is a diagram illustrating a wireless communication system according to an embodiment of the present invention. The wireless communication system 100 may be a mobile network system in compliance with the 3rd Generation Partnership Project (3GPP) specifications, and may include a UE 102, a BS 104, and a core network (CN) 106. The BS 104 may be a part of a radio access network (RAN) 103. In other words, the network (NW) may include more than one BS. Since the present invention is focused on the UE TX performance enhancement reporting scheme, only one BS 104 (which is wirelessly connected to UE 102) is shown in FIG. 1 for brevity and simplicity. In the following, the terms “BS’ and “NW” may be interchangeable.

The UE 102 may include a processor 112, a memory 114, a control circuit 116, and a wireless communication circuit 118. The wireless communication circuit 118 acts as a network interface circuit, and includes a TX circuit 120 and an RX circuit 122. The memory 114 is configured to store a program code. The processor 112 is configured to load and execute the program code to manage operations of UE 102. The control circuit 116 is configured to control communications with BS 104. For example, the control circuit 116 controls the TX circuit 120 of the wireless communication circuit 118 to send frames to BS 104, and controls the RX circuit 122 of the wireless communication circuit 118 to receive frames transmitted from BS 104. It should be noted that only the components pertinent to the present invention are illustrated in FIG. 1. In practice, UE 102 may include additional components to achieve other designated functions.

In this embodiment, UE 102 and BS 104 support the proposed UE TX performance enhancement reporting. That is, UE 102 is capable of informing BS 104 of its TX performance enhancement, and BS 104 is capable of acknowledging UE TX performance enhancement reported by UE 102. For example, the control circuit 116 is configured to generate a message MSG, and instruct the wireless communication circuit 118 (particularly, TX circuit 120 of wireless communication circuit 118) to send the message MSG to BS 104, where the message MSG includes at least one bit indicative of UE TX performance enhancement. After receiving the message MSG sent from UE 102, BS 104 can parse the message MSG to obtain information associated with UE TX performance enhancement.

In a first UE TX performance enhancement reporting design, the UE TX performance enhancement is relevant to a target property being an A-MPR. Because of regulatory UE-UE coexistence requirements (e.g., a UE-UE coexistence requirement of −50 dBm/MHz), BS 104 can use network signaling to configure UE 102 with an A-MPR (e.g., power backoff) to meet requirements. For example, in 3GPP TS 36.102, a network signaling value NS_24 is used for band B256 to configure UE 102 with an A-MPR (e.g., A-MPR≤3.5 dB). However, this causes coverage loss between BS 104 and UE 102. In this embodiment, UE 102 may support advanced TX design (e.g., TX DPD and/or low PAPR) and has enhanced TX RF performance. To address this issue resulting from a high A-MPR (e.g., 3.5 dB) triggered by a network signaling value (e.g., NS_24), the proposed UE TX performance enhancement reporting design enables UE 102 to directly or indirectly report its TX performance enhancement to BS 104 via UE capability relevant to A-MPR or other additional capabilities, for enhancement of the TX coverage that can fulfill user experiences.

In some embodiments of the present invention, the at least one bit included in the message MSG may record an enhanced value of the target property (e.g., an enhanced A-MPR which is lower than an original A-MPR triggered by a network signaling value such as NS_24).

In some embodiments of the present invention, the at least one bit included in the message MSG may record a difference between an original value and an enhanced value of the target property (e.g., an A-MPR difference between an enhanced A-MPR and an original A-MPR, where the enhanced A-MPR is lower than the original A-MPR triggered by a network signaling value such as NS_24).

In some embodiments of the present invention, the at least one bit included in the message MSG may record an enhanced value of a different property, where there is a predetermined relationship between the enhanced value of the different property and an enhanced value of the target property. For example, the different property may be TX output power, and the enhanced value carried by the at least one bit in the message MSG may be an enhanced TX output power level, where BS 104 can derive an enhanced A-MPR (which is lower than an original A-MPR triggered by a network signaling value such as NS_24) from the enhanced TX output power level according to a predetermined relationship between the enhanced A-MPR and the enhanced TX output power level. For another example, the different property may be power headroom report (PHR) information, and the enhanced value carried by the at least one bit in the message MSG may be an enhanced power headroom level, where BS 104 can derive an enhanced A-MPR (which is lower than an original A-MPR triggered by a network signaling value such as NS_24) from the enhanced power headroom level according to a predetermined relationship between the enhanced A-MPR and the enhanced power headroom level.

In some embodiments of the present invention, the at least one bit included in the message MSG may record a difference between an original value and an enhanced value of a different property, where there is a predetermined relationship between the difference of the different property and an enhanced value of the target property.

For example, the different property may be TX output power, and the difference carried by the at least one bit in the message MSG may be a TX output power difference, where BS 104 can derive an enhanced A-MPR (which is lower than an original A-MPR triggered by a network signaling value such as NS_24) from the TX output power difference according to a predetermined relationship between the enhanced A-MPR and the TX output power difference.

For another example, the different property may be PHR information, and the difference carried by the at least one bit may be a power headroom difference, where BS 104 can derive an enhanced A-MPR (which is lower than an original A-MPR triggered by a network signaling value such as NS_24) from the power headroom difference according to a predetermined relationship between the enhanced A-MPR and the power headroom difference.

For still another example, the different property may be ACLR, and the difference carried by the at least one bit in the message MSG may be an intermodulation distortion (IMD) difference of a specific order that is relevant to ACLRi enhancement, where i is an index that depends on an order of IMD. In other words, IMDn is relevant to specific ACLRi, where the index n is an order of IMD. For example, ACLR1 (i=1) is mapped to IMD3 (n=3), ACLR2 (i=2) is mapped to IMD5 (n=5), ACLR3 (i=3) is mapped to IMD7 (n=7), ACLR4 (i=4) is mapped to IMD9 (n=9), and so on. The TX output power difference between an enhanced TX output power and an original TX output power can be derived from the following formula for getting an enhanced A-MPR which is lower than an original A-MPR triggered by a network signaling value such as NS_24.

$$IMDn ( dBm ) = {n}^{*} TX\_power - {( n - 1 )}^{*} OIPn \qquad ( 1 )$$

In above formula (1), IMDn represents an nth-order IMD, TX power represents the TX output power, and OIPn represent an nth-order output intercept point. When OIPn is a constant, a 1 dB TX A-MPR difference results in an n*1 dB IMDn change. For example, when OIP3 is a constant, a 1 dB TX A-MPR difference results in a 3 dB IMD3 change. Hence, BS 104 can derive an enhanced A-MPR from an original A-MPR (which is specified in the 3GPP specification and known to BS 104) and an IMD difference that is reported by UE 102.

In some embodiments of the present invention, the at least one bit included in the message MSG may include multiple bits under a condition that UE TX performance enhancement is relevant to A-MPR. For example, the aforementioned enhanced value or the aforementioned difference between an enhanced value and an original value may be indicated by multiple bits included in the same message MSG.

In some embodiments of the present invention, the at least one bit included in the message MSG may include only a single bit that is used to indicate presence of UE TX performance enhancement under a condition that UE TX performance enhancement is relevant to A-MPR. Hence, after receiving the message MSG from UE 102, BS 104 is aware of UE 102 being a good UE with advanced TX design and enhanced TX RF performance (i.e., enhanced A-MPR).

In some embodiments of the present invention, the UE TX performance enhancement corresponds to an enhanced A-MPR, and an original resource block (RB) allocation is specified to be used under an original A-MPR. After sending the message MSG to BS 104, UE 102 may perform a TX operation by using an adjusted RB allocation under the enhanced A-MPR, where the adjusted RB allocation is different from the original RB allocation. Specifically, due to the enhanced A-MPR being lower than the original A-MPR, the used UE A-MPR table's RB allocation can also be adjusted and known to BS 104.

In some embodiments of the present invention, the UE TX performance enhancement corresponds to an enhanced A-MPR, an original A-MPR is specified to be used in response to a network signaling value (e.g., NS_24), and BS 104 can still send the same network signaling value (e.g., NS_24) to UE 102 being a good UE with advanced TX design and enhanced TX RF performance. Specifically, after sending the message MSG to inform BS 104 of UE TX performance enhancement relevant to A-MPR, UE 102 receives the same network signaling value (e.g., NS_24) from BS 104; and in response to the received network signaling value (e.g., NS_24), UE 102 performs a TX operation by using the enhanced A-MPR which is lower than the original A-MPR (e.g., 3.5 dB) requested by the received network signaling value (e.g., NS_24).

In some embodiments of the present invention, the UE TX performance enhancement corresponds to an enhanced A-MPR of 0 dB (i.e., no power backoff required). Since a OdB A-MPR does not need any network signaling from BS 104, BS 104 can decide whether it is applicable to send a network signaling value (e.g., NS_24) to UE 102 or not. In a case where BS 104 decides not to send a network signaling value (e.g., NS_24) to UE 102, UE 102 receives no network signaling value (e.g., NS_24) relevant to A-MPR from BS 104 after the message MSG is sent to BS 104. In other words, after sending the message MSG to inform BS 104 of an enhanced A-MPR of 0 dB, UE 102 may not expect to receive a network signaling value (e.g., NS_24) from BS 104.

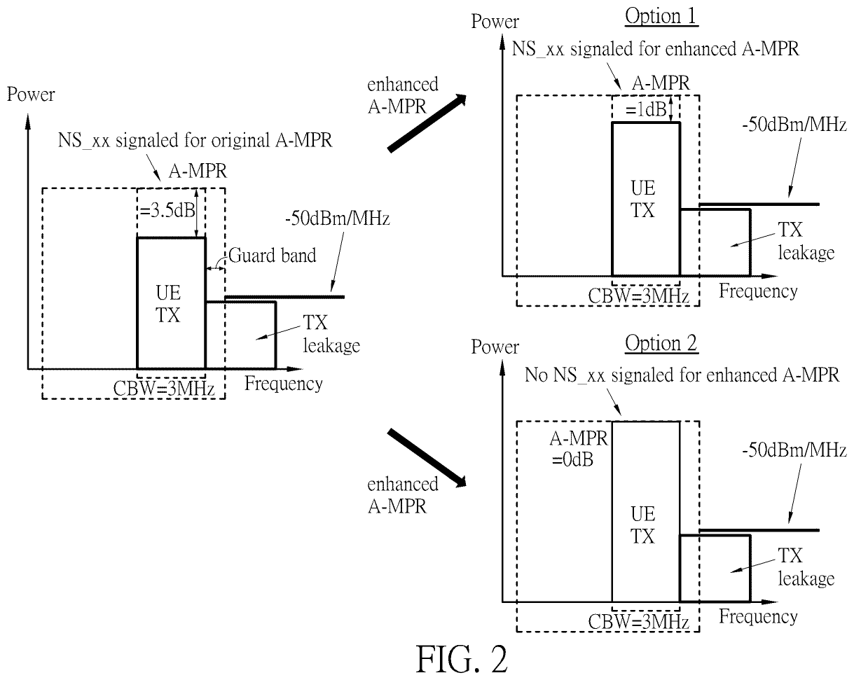

FIG. 2 is a diagram illustrating a case where UE 102 updates enhanced UE TX performance relevant to A-MPR to BS 104. An original A-MPR is specified to be used in response to a network signaling value NS xx. Considering a first case where the message MSG reported by UE 102 indicates an enhanced A-MPR of a non-zero dB such as 1 dB. After receiving the message MSG (which indicates an enhanced A-MPR of a non-zero dB such as 1 dB) from UE 102, BS 104 transmits the same network signaling value NS xx to UE 102. In response to the network signaling value NS xx, UE 102 may perform a TX operation by using the enhanced A-MPR rather than the original A-MPR due to the fact that UE 102 is a good UE with advanced TX design (e.g., TX DPD or low PAPR) and enhanced TX RF performance. Considering a second case where the message MSG reported by UE 102 indicates an enhanced A-MPR of 0 dB. After receiving the message MSG (which indicates an enhanced A-MPR of 0 dB) from UE 102, BS 104 decides not to transmit the same network signaling value NS_xx to UE 102. After sending the message MSG (which indicates an enhanced A-MPR of 0 dB) to BS 014, UE 102 may not receive the network signaling value NS xx from BS 104, and may perform a TX operation by using a 0 dB A-MPR (i.e., no power backoff applied).

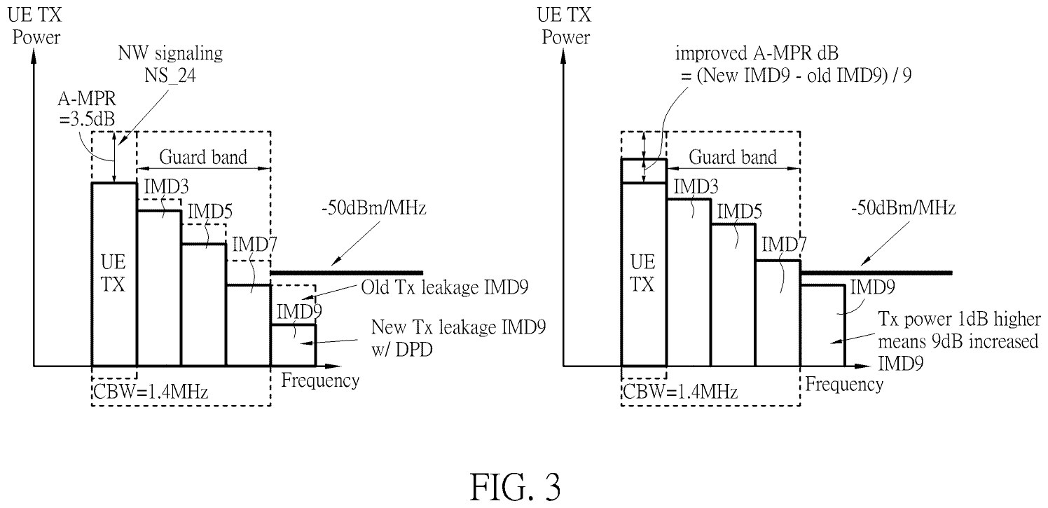

FIG. 3 is a diagram illustrating a case where UE 102 updates enhanced UE TX performance relevant to ACLR to BS 104. Since UE 102 reports capability relevant to the enhanced ACLRi/IMDn, TX A-MPR reduction can be achieved at UE 102 being a good UE with advanced TX design (e.g., TX DPD or low PAPR) and enhanced TX RF performance. For example, the message MSG reports an IMDn (n=9) difference that is relevant to ACLRi (i=4) enhancement. The A-MPR enhancement can be derived from the IMD9 difference between an enhanced (new) IMD9and an original (old) IMD9 according to above formula (1). As shown in FIG. 3, an enhanced A-MPR is derived from subtracting (new IMD9—old IMD9)/9 from an original A-MPR of 3.5 dB.

In a second UE TX performance enhancement reporting design, the UE TX performance enhancement is relevant to a target property being an MPR or an EVM, where

$$EVM = \frac{1}{\sqrt{SNR}} .$$

UE 102 needs to meet ACLR requirement and different modulation EVM requirements, which results in applying an MPR. Specifically, when considering higher-order modulation scheme, transmit bandwidth configuration and specified TX power class, for meeting ACLR and modulation signal-to-noise ratio (SNR) requirements, UE 102 can apply an MPR to meet the requirements. For example, in 3GPP TS 38.101-1, UE 102 can use different MPR values for meeting ACLR requirements under different modulation schemes. However, this causes coverage loss when supporting higher TX throughput or higher-order modulation. In this embodiment, UE 102 may be a good UE with advanced TX design (e.g., TX DPD and/or low PAPR) and has enhanced TX RF performance. To address this issue resulting from a higher-order modulation scheme, the UE TX performance enhancement reporting design enables UE 102 to directly or indirectly report its TX performance enhancement to BS 104 via UE capability relevant to MPR/EVM or other additional capabilities, for enhancement of the TX coverage or TX throughput that can fulfill user experiences.

In some embodiments of the present invention, the at least one bit included in the message MSG may record an enhanced value of the target property such as an enhanced MPR (i.e., a lower MPR) or an enhanced EVM (i.e., a lower EVM or a better SNR).

In some embodiments of the present invention, the at least one bit included in the message MSG may record a difference between an original value and an enhanced value of the target property (e.g., an MPR difference or an EVM difference).

In some embodiments of the present invention, the at least one bit included in the message MSG may record an enhanced value of a different property, where there is a predetermined relationship between the enhanced value of the different property and an enhanced value of the target property. For example, the different property may be TX output power, and the enhanced value carried by the at least one bit in the message MSG may be an enhanced TX output power level, where BS 104 can derive an enhanced MPR from the enhanced TX output power level according to a predetermined relationship between the enhanced MPR and the enhanced TX output power level. For another example, the different property may be PHR information, and the enhanced value carried by the at least one bit in the message MSG may be an enhanced power headroom level, where BS 104 can derive an enhanced MPR from the enhanced power headroom level according to a predetermined relationship between the enhanced MPR and the enhanced power headroom level.

In some embodiments of the present invention, the at least one bit included in the message MSG may record a difference between an original value and an enhanced value of a different property, where there is a predetermined relationship between the difference of the different property and an enhanced value of the target property. For example, the different property may be TX output power, and the difference carried by the at least one bit in the message MSG may be a TX output power difference, where BS 104 can derive an enhanced MPR from the TX output power difference according to a predetermined relationship between the enhanced MPR and the TX output power difference. For another example, the different property may be PHR information, and the difference carried by the at least one bit in the message MSG may be a power headroom difference, where BS 104 can derive an enhanced MPR from the power headroom difference according to a predetermined relationship between the enhanced MPR and the power headroom difference.

In some embodiments of the present invention, the at least one bit included in the message MSG may include multiple bits under a condition that the UE TX performance enhancement is relevant to MPR/EVM. For example, the aforementioned enhanced value or the aforementioned difference between an enhanced value and an original value may be indicated by multiple bits in the same message MSG.

In some embodiments of the present invention, the at least one bit included in the message MSG may include only a single bit that is used to indicate presence of UE TX performance enhancement under a condition that the UE TX performance enhancement is relevant to MPR/EVM. Hence, after receiving the message MSG from UE 102, BS 104 is aware of UE 102 being a good UE with advanced TX design and enhanced TX RF performance (i.e., enhanced MPR/EVM).

In a third UE TX performance enhancement reporting design, the UE TX performance enhancement is relevant to a target property being an ACLR. UE 102 needs to meet ACLR specification requirements, which limits TX output power capability. In this embodiment, UE 102 is a good UE with advanced TX design and enhanced TX RF performance (i.e., enhanced ACLR), and has a lot of margin for TX output power. That is, an advanced UE with good ACLR performance has the potential to boost the TX output power and still meet the ACLR specification requirements. Hence, the UE TX performance enhancement reporting design enables UE 102 to directly or indirectly report its TX performance enhancement to BS 104 via UE capability relevant to ACLR for TX output power boosting.

In some embodiments of the present invention, the at least one bit included in the message MSG records an enhanced ACLR for one of a plurality of power classes. Specifically, for each PCi (power class i), an enhanced ACLR1 level that is mapped to IMD3 and supported by UE 102 is reported to BS 104 through the message MSG.

In some embodiments of the present invention, the at least one bit included in the message MSG records a difference between an original ACLR and an enhanced ACLR for one of a plurality of power classes. Specifically, for each PCi (power class i), a difference Xi-dB between an original (old) ACLR1 and an enhanced (new) ACLR1, both mapped to IMD3 and supported by UE 102, are reported to BS 104. For example, the difference Xi-dB may be reported by 1-bit capability. Hence, the at least one bit may include N (N≥2) bits that are set for N power classes, respectively.

In some embodiments of the present invention, the at least one bit included in the message MSG may have only a single bit. For example, new enhanced ACLR1 tables for all power classes are specified in the 3GPP specification, and only one bit is needed for UE reporting or BS signaling for triggering the use of the new enhanced ACLR1 tables.

There is no behavior change in UE 102 and BS 104 in the absence of new ACLR enhancement and reporting. With reporting of UE's enhanced ACLR or difference between original ACLR and enhanced ACLR, BS 104 can use a conservative way to determine a power level of a boosted TX output power by using the aforementioned formula (1). The aforementioned formula (1) indicates that 3 dB ACLR1 enhancement can allow a 1 dB increment of the TX output power. Similarly, by using UE's new ACLR or new ACLR difference from new enhanced ACLR1 tables trigged by 1-bit capability reporting, BS 104 can use a conservative way to determine a power level of a boosted TX output power by using the aforementioned formula (1).

UE 102 sends the message MSG to inform BS 104 of an enhanced UE TX ACLR. In one exemplary design, there is no new BS signaling introduced, and BS 104 may allow UE 102 to use an additional TX power once UE 102 reports its new capability. In another exemplary design, there is new BS signaling introduced, and BS 104 may decide whether to allow UE 102 to use an additional TX power or not.

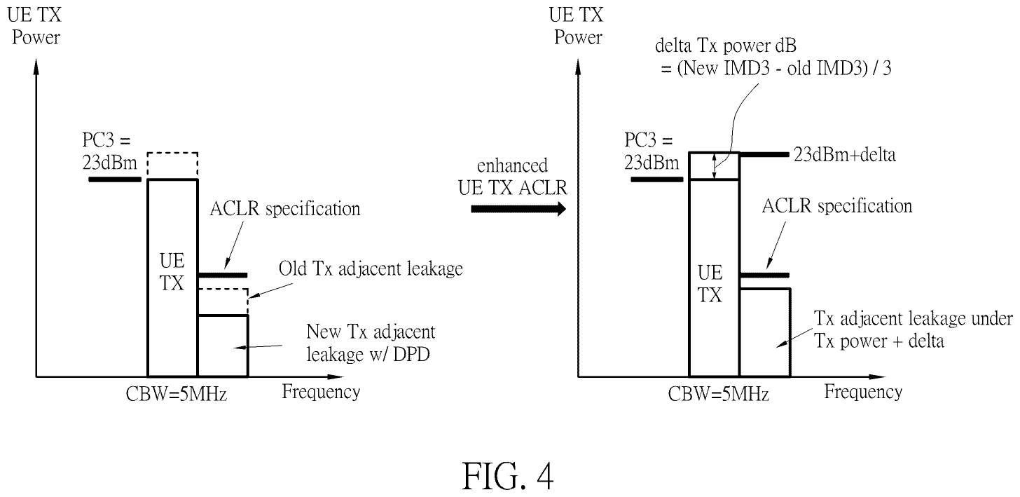

Since UE 102 is a good UE with advanced TX design (e.g., TX DPD and/or low PAPR) and enhanced TX RF performance (e.g., enhanced ACLR), the power level of the boosted TX output power can be used by UE 102 to enhance the TX coverage under the condition that the ACLR specification requirements are still met. Specifically, after sending the message MSG to BS 104, UE 102 may perform a TX operation by using a boosted TX output power under a power class, wherein a power level of the boosted TX output power is higher than a maximum TX output power level specified by the power class. FIG. 4 is a diagram illustrating that UE 102 boosts its TX output power for power class 2 (PC2) due to an enhanced ACLR. The maximum TX output power level specified by power class 3 (PC3) is 23 dBm. Since UE 102 is a good UE with advanced TX design (e.g., TX DPD and/or low PAPR) and enhanced TX RF performance (e.g., enhanced ACLR), UE 102 can use the boosted TX output power 23 dBm+delta and still meets the ACLR specification. There may be an upper bound for additionally increased TX power. Taking 23 dBm PC3 as an example, the increased TX power is lower than 23 dBm+1.5 dB, where the delta dB=0.5*(PC2−PC3). This restriction is not a hard rule, and is just used as a reference to avoid ambiguity between PC2 and PC3 specified by the 3GPP specification.

The higher UE TX MPR can be from the use of the higher-order modulation. Since UE 102 is a good UE with advanced TX design (e.g., TX DPD and/or low PAPR) and enhanced TX RF performance (e.g., enhanced ACLR), the enhanced UE TX ACLR can be enabled by UE 102 to switch from an original modulation and coding scheme (MCS) to an enhanced MCS under the same MPR, where an order of the enhanced MCS is higher than an order of the original MCS. For example, each of UE 102 and BS 104 has two MPR-MCS tables. One of the MPR-MCS tables is a default MPR-MCS table (Table 1) used under a condition that UE 102 does not use the message MSG to report UE TX ACLR enhancement to BS 104. An example of the default MPR-MCS table (Table 1) is shown as follows.

TABLE 1

| | | | MPR (dB) | | |
|---|---|---|---|---|---|
| | | | Edge RB | Outer RB | Inner RB |
| Modulation | | | allocations | allocations | allocations |
| DFT-s- | Pi/2 | | ≤3.5 | ≤0.5 | 0 |
| OFDM | BPSK | | | | |
| | QPSK | | ≤3.5 | ≤1 | 0 |
| | 16 | QAM | ≤3.5 | ≤2 | ≤1 |
| | 64 | QAM | ≤3.5 | ≤2.5 | |
| | 256 | QAM | ≤4.5 | | |
| CP-OFDM | QPSK | | ≤3.5 | ≤3 | ≤1.5 |
| | 16 | QAM | ≤3.5 | ≤3 | ≤2 |

| | | |
|---|---|---|
| 64 | QAM | ≤3.5 |
| 256 | QAM | ≤6.5 |

The other of the MPR-MCS tables is a new MPR-MCS table (Table 2) used under a condition that UE 102 uses the message MSG to report UE TX ACLR enhancement to BS 104. An example of the new MPR-MCS table (Table 2) is shown as follows.

TABLE 2

| | | | MPR (dB) | | |
|---|---|---|---|---|---|
| | | | Edge RE | Outer RB | Inner RB |
| Modulation | | | allocations | allocations | allocations |
| DFT-s- | Pi/2 BPSK, | | ≤3.5 | ≤0.5 | 0 |
| OFDM | QPSK (new) | | | | |
| | QPSK, | | ≤3.5 | ≤1 | 0 |
| | 16 | QAM (new) | | | |
| | 16 | QAM | ≤3.5 | ≤2 | ≤1 |
| | 64 | QAM | ≤3.5 | ≤2.5 | |
| | 256 | QAM | ≤4.5 | | |
| CP-OFDM | QPSK, | | ≤3.5 | ≤3 | ≤1.5 |
| | 16 | QAM (new) | | | |
| | 16 | QAM | ≤3.5 | ≤3 | ≤2 |

| | | |
|---|---|---|
| 64 | QAM | ≤3.5 |
| 256 | QAM | ≤6.5 |

Hence, when the enhanced UE TX ACLR is not enabled, UE 102 may apply Pi/2 BPSK MPR setting for DFT-s-OFDM; and when the enhanced UE TX ACLR is enabled and known by BS 104, UE 102 and BS 104 are allowed to switch the signal modulation to QPSK under the same MPR setting. In this way, the TX throughput can be enhanced due to a higher-order modulation used under the same MPR setting.

Alternatively, since UE 102 is a good UE with advanced TX design (e.g., TX DPD and/or low PAPR) and enhanced TX RF performance (e.g., enhanced ACLR), the enhanced UE TX ACLR can be enabled by UE 102 to switch from an original MPR to an enhanced MPR under the same MCS, where the enhanced MPR is lower than the original MPR. In this way, the TX coverage can be enhanced due to a lower MPR setting used under the same modulation setting.

Alternatively, since UE 102 is a good UE with advanced TX design (e.g., TX DPD and/or low PAPR) and enhanced TX RF performance (e.g., enhanced ACLR), the enhanced UE TX ACLR can be enabled by UE 102 to switch from an old combination of an original MCS and an original MPR to a new combination of an enhanced MCS and an enhanced MPR, where an order of the enhanced MCS is higher than an order of the original MCS, and the enhanced MPR is lower than the original MPR. In this way, TX coverage and TX throughput can be jointly enhanced due to a lower MPR setting and a higher-order modulation.

To put it simply, an original modulation scheme and an original MPR are specified to be used under an original ACLR. After sending the message MSG to BS 104, UE 102 may perform a TX operation by using at least one of an enhanced MPR and an enhanced modulation scheme, where the enhanced MPR is lower than the original MPR, and an order of the enhanced modulation scheme is higher than an order of the original modulation scheme.

Those skilled in the art will readily observe that numerous modifications and alterations of the device and method may be made while retaining the teachings of the invention. Accordingly, the above disclosure should be construed as limited only by the metes and bounds of the appended claims.

What is claimed is:

1. A wireless communication method employed by a user equipment (UE), comprising:
generating a message, wherein the message comprises at least one bit indicative of UE transmit (TX) performance enhancement; and
sending the message to a base station (BS).

2. The wireless communication method of claim 1, wherein the UE TX performance enhancement is relevant to a target property being an additional maximum power reduction (A-MPR), or a maximum power reduction (MPR), or an error vector magnitude (EVM).

3. The wireless communication method of claim 2, wherein the at least one bit records an enhanced value of the target property.

4. The wireless communication method of claim 2, wherein the at least one bit records a difference between an original value and an enhanced value of the target property.

5. The wireless communication method of claim 2, wherein the at least one bit records an enhanced value of a different property, where there is a predetermined relationship between the enhanced value of the different property and an enhanced value of the target property.

6. The wireless communication method of claim 2, wherein the at least one bit records a difference between an original value and an enhanced value of a different property, where there is a predetermined relationship between the difference of the different property and an enhanced value of the target property.

7. The wireless communication method of claim 6, wherein the difference is an intermodulation distortion (IMD) difference of a specific order that is relevant to adjacent channel leakage ratio (ACLR) enhancement.

8. The wireless communication method of claim 2, wherein the at least one bit comprises multiple bits.

9. The wireless communication method of claim 2, wherein the at least one bit comprises only a single bit.

10. The wireless communication method of claim 2, wherein the UE TX performance enhancement corresponds to an enhanced A-MPR, an original resource block (RB) allocation is specified to be used under an original A-MPR, and the wireless communication method further comprises:
after sending the message to the BS, performing a TX operation by using an adjusted RB allocation under the enhanced A-MPR, wherein the adjusted RB allocation is different from the original RB allocation.

11. The wireless communication method of claim 2, wherein the UE TX performance enhancement corresponds to an enhanced A-MPR, an original A-MPR is specified to be used in response to a network signaling (NS) value, and the wireless communication method further comprises:
receiving the NS value from the BS; and
in response to the NS value, performing a TX operation by using the enhanced A-MPR.

12. The wireless communication method of claim 2, wherein the UE TX performance enhancement corresponds to an enhanced A-MPR of 0 dB, and the wireless communication method further comprises:
after sending the message to the BS, receiving no network signaling (NS) value relevant to A-MPR from the BS.

13. The wireless communication method of claim 1, wherein the UE TX performance enhancement is relevant to an adjacent channel leakage ratio (ACLR).

14. The wireless communication method of claim 13, wherein the at least one bit records an enhanced ACLR for one of a plurality of power classes.

15. The wireless communication method of claim 13, wherein the at least one bit records a difference between an original ACLR and an enhanced ACLR for one of a plurality of power classes.

16. The wireless communication method of claim 15, wherein the at least one bit comprises a plurality of bits that are set for the plurality of power classes, respectively.

17. The wireless communication method of claim 13, wherein the at least one bit comprises only a single bit.

18. The wireless communication method of claim 13, further comprising:
after sending the message to the BS, performing a TX operation by using a boosted TX output power under a power class, wherein a power level of the boosted TX output power is higher than a maximum TX output power level specified by the power class.

19. The wireless communication method of claim 13, wherein an original modulation scheme and an original maximum power reduction (MPR) are specified to be used under an original ACLR, and the wireless communication method further comprises:
after sending the message to the BS, performing a TX operation by using at least one of an enhanced MPR and an enhanced modulation scheme, wherein the enhanced MPR is lower than the original MPR, and an order of the enhanced modulation scheme is higher than an order of the original modulation scheme.

20. A user equipment (UE) comprising:
a wireless communication circuit; and
a control circuit, configured to generate a message, and instruct the wireless communication circuit to send the message to a base station (BS);
wherein the message comprises at least one bit indicative of UE transmit (TX) performance enhancement.
